(19) United States
(12) Patent Application Publication
(10) Pub. No.: US 2016/0334316 A1
(43) Pub. Date: Nov. 17, 2016

(54) SLURRY PROCESS METER

(71) Applicant: Concentric Meter Corporation, Longmont, CO (US)

(72) Inventors: Donald R. Cage, Longmont, CO (US); Michael N. Schott, Loveland, CO (US); Kristian S. Schartau, Erie, CO (US)

(21) Appl. No.: 15/152,864

(22) Filed: May 12, 2016

Related U.S. Application Data
(60) Provisional application No. 62/161,818, filed on May 14, 2015.

(51) Int. Cl. G01N 9/00; G01F 1/84; G01N 11/00

(52) U.S. Cl. CPC G01N 9/002; G01N 11/00; G01F 1/84

(57) ABSTRACT

A vibrating element type process meter is disclosed, to measure slurry mass flow rate, density and viscosity, and the mass and volume fraction of particles in a slurry. An example may implement a vibrating element type sensor to measure the apparent mass flow rate and density and viscosity of a slurry, and by using slurry particle properties including particle size and shape and density, the true mass flow rate and slurry density may be determined. An algorithm may be applied to compensate the apparent mass flow rate and density by using the measured slurry viscosity and particle property data to derive a true slurry density.

### CROSS REFERENCE TO RELATED APPLICATIONS

This application claims the priority benefit of U.S. Provisional Patent Application No. 62/161,818 filed May 14, 2015 for “Process Meter for Measuring Slurry Density and Viscosity with Compensation for Slurry Particle Properties,” hereby incorporated by reference in its entirety as though fully set forth herein.

### BACKGROUND

In the field of vibrating element type density sensing process meters and Coriolis mass flow rate meters, the accurate measurement of slurry density and slurry mass flow rate has been difficult to achieve, because particles having a different density than the base fluid in which they are mixed move relative to the vibrating fluid and thus their inertial properties cannot be accurately sensed and measured by the vibrating element. The result is an apparent density measurement or mass flow rate measurement that indicates a slurry density or mass flow rate that may not be the true density or true mass flow rate of the slurry mixture.

For example, in the hydraulic fracturing (“fracking”) industry, a base fluid having a known density, such as water, is often mixed with solid particles such as, sand to form fracking fluid slurry. This mixture is blended then injected into a gas or oil well, to improve its production capability. The exact density and volume fraction of the mixture may be important to know and control to achieve the desired results from a fracking operation. Since the apparent density and mass flow rate and the viscosity of the slurry mixture can be measured with a vibrating element type sensor, it may be that the only other information needed may be the base fluid density, particle size, shape, and density. For example, in fracking applications, the sand particles, typically referred to as “propant,” are often specified and purchased by size, shape, and density, and certifications on those properties are normally supplied with the propant.

### BRIEF DESCRIPTION OF THE DRAWINGS

FIG. 1A is an isometric view of an example slurry process meter.

FIG. 1B is another view of the example slurry process meter of FIG. 1A, shown looking down one axis.

FIG. 2A is an isometric view of an example vibrating element assembly.

FIG. 2B is an isometric view of an example vibrating element assembly shown as a finite element analysis deflected shape plot.

FIG. 2C is an axis view of the example finite element analysis deflected shape plot of FIG. 2B.

FIG. 3 is a diagram illustrating an example particle immersed in vibrating fluid showing the drag and buoyancy forces that can be developed on the particle thereby causing particle vibration.

FIG. 4 is a set of graphs from analyses of example fluid and particle motion where the fluid is vibrating and a particle is subjected to this vibrating fluid, and the fluid has the same density as the particle.

FIG. 5 is a set of graphs from analyses of example fluid and particle motion where the fluid is vibrating and a particle is subjected to this vibrating fluid, and the fluid has a significantly different density than the particle.

FIG. 6 is a graph comparing Density Compensation percent value for different example particle mesh sizes and fluid viscosities.

FIG. 7A is a block diagram of an example slurry blending system such as found on a hydraulic fracturing blender truck, showing implementation of the example process meter.

FIG. 7B is a block diagram of an example slurry blending system such as found on a hydraulic fracturing blender truck, showing implementation of two process meters.

FIG. 8A is a section view of an example slurry process meter showing how fluid may be forced to move proportionally with the motion of the vibrating element.

FIG. 8B is a section view of an example slurry process meter showing how fluid may be forced to move proportionally with the motion of the vibrating, element and showing velocity profiles resulting from such motion.

FIG. 9 is a graph describing example viscosity metric characteristics of three fluids with different viscosities which are generally Newtonian in nature.

FIG. 10 is, a graph describing example viscosity metric characteristics two fluids with different viscosities which are generally non-Newtonian in nature.

### DETAILED DESCRIPTION

An example slurry process meter is disclosed. In an example, the slurry process meter may be implemented to determine the true density and true mass flow rate of a slurry mixture utilizing the base fluid density and/or base mass flow rate, the apparent density and/or the apparent mass flow rate, that can be derived from the change in a vibration characteristic of a vibrating element sensor, utilizing measured fluid viscosity, base fluid density, and/or base fluid mass flow rate, and particle properties of many industrial slurry applications. The measured change in a vibration characteristic may be a change in the frequency of vibration, or in the case of a Coriolis flow meter, a change in amplitude or phase of the vibration on the vibrating element.

A vibrating element type density sensor or densitometer can operate on the principle that the undamped natural frequency of the vibrating element follows Equation 1 below:

$${ω}_{n} = \sqrt{\frac{K}{Me}} \qquad Eq 1$$

Where:

ωₙ=Undamped Natural Frequency (radians per second)

K=Element Stiffness (Newtons per meter)

Me=Mass of Vibrating element (Kg)

If there is damping in the system, then a damped natural frequency can be defined as in Equation 2 below:

ω_{d}=ωₙ*\sqrt{1−ζ²} Eq 2

Where:

ω_{d}=Damped Natural Frequency (radians per second)

ωₙ=Undamped Natural Frequency (From Equation 1 above)

ζ=Critical Damping Ratio (Zeta)

When used as a density sensor, the vibrating element may be subjected to a fluid to be measured and the vibration may then incorporate additional mass from the fluid, thereby adding to the “Me” mass term in the denominator of Equation 1 above. This is shown in Equation 3 below:

$${ω}_{n} = \sqrt{\frac{K}{Me + Mf}} \qquad Eq 3$$

Where:

Me+Mf=Mass of the Vibrating Element plus Mass of the Vibrating Fluid

The additional mass from the vibrating fluid MI may add to the total mass, thereby lowering the vibration frequency in a predictable way. Since the mass of the fluid may be contained in a fixed volume, the fluid mass term in Equation 3 above may be proportional to the fluid density. These devices may therefore be calibrated on fluids of known density and thereby make accurate density sensing type process meters. The mass terms Me and Mf just described may not necessarily be the actual total mass of either the vibrating element or the fluid respectively. Instead they may be the “modal-mass” of each of these, a term that describes the effective mass of a vibrating object where not all the entire object is vibrating at the same amplitude. Similarly the term K can also be a modal-stiffness term, since not all the entire vibrating element may be involved in the stiffness term. These terms are commonly used in the field of vibration analysis.

Similarly, in a Coriolis type mass flow meter utilizing a vibrating element, the combination of mass flow rate and vibration of the vibrating element will cause a change in a vibration characteristic of the vibrating element such as a change in the amplitude or the phase of vibration of the vibrating element. Here again, the change in the vibration characteristic is proportionally related to the mass flow rate of the fluid.

The vibration effects just described are based on the fluid vibrating with amplitude proportionally related to the vibration amplitude of the vibrating element. This assumption is generally accurate for “pure fluids” here described as being devoid of particulate matter or voids or bubbles. However when the fluid is not pure, and contains particulate matter or voids or bubbles, and especially where the particles have a different density than the base fluid density, the particles may not necessarily vibrate with an amplitude proportionally related to the vibration amplitude of the vibrating element. In this case, the measurement of the density or of the mass flow rate of a slurry may therefore be in error due to the particulate matter or voids or bubbles.

As a visual example of this phenomenon, envision a rubber ball having a density close to that of water, sealed in a glass jar filled with air. If you shake the jar, the rubber does not track the motion of the jar and the air inside, but rather tends to slip through the air to bounce off the sides of the jar. If you then replace the air in the jar with water and again shake the jar, the rubber ball closely tracks the motion of the jar and the water inside, and does not bounce around inside the jar. The difference is that the water has nearly the same density as the rubber ball, and therefore provides a buoyancy force on the ball causing the ball to accelerate and move with an amplitude more proportionally with the motion of the jar and water.

This same phenomenon occurs in a vibrating slurry under the influence of a vibrating element where the density of the slurry particles are different than the density of the surrounding fluid. In this case, the slurry particles may move relative to the fluid and their inertial effects may not be accurately sensed by the vibrating element. If the particle density is heavier than that of the fluid, the particle tends to lag behind the motion of the surrounding fluid. Alternately, if the particle density is less than that of the fluid, the particle tends to move ahead of the motion of the fluid. This relative motion phenomenon is described in more detail here below

A particle immersed in a vibrating fluid may experience an oscillating buoyancy force and if the particle is moving relative to the surrounding fluid, an additional viscous drag force. The buoyancy force on a particle immersed in a dense base fluid subject to acceleration (from vibration or some other source) can be expressed by Equation 4 below:

F_{bouy}=ρ_{fluid}*Volₚₐᵣₜ*A_{fluid} Eq 4

Where:

F_{bouy}=Buoyancy Force

ρ_{fluid}=Base Fluid Density

Volₚₐᵣₜ=Volume of the particle

A_{fluid}=Acceleration of the Fluid

In addition, Equation 5 below relates the viscous drag force on a spherical particle moving through a viscous fluid as follows:

F_{visc}=6*π*μ*R*Vrel Eq 6

Where:

F_{Visc}=Viscous Drag Force

μ=Dynamic Viscosity

R=Radius of a spherical particle

Vrel=Particle velocity relative to surrounding fluid

Most particles in industrial slurries are not perfectly spherical, and therefore cause higher drag forces than predicted by Equation 5 above. Therefore Equation 6 below incorporates an additional drag coefficient term as follows:

F_{visc}=C_{d}*6*π*μ*R*Vrel Eq 6

Where:

C_{d}=Coefficient of Drag

The coefficient of drag term in Equation 6 above is proportionally related to the shape of the particles. The numerical value of this term can be determined experimentally or deduced from material data sheets that are often supplied with commercially produced particulate products such as propant for (racking fluid, Portland cement for well cementing, and bentonite for well drilling “mud”. The shape of particles is often specified as a “sphericity” parameter relating to how spherical a particle is.

Equation 6 above is accurate at lower Reynolds numbers. At higher Reynolds numbers, other drag force equations can be used, for example Equation 7 below:

F_{visc}=(Cd*Ap*p_{fluid}*Vrel²)/2 Eq 7

Where:

Fvisc=Viscous Drag Force

C_{d}=Coefficient of Drag

Ap=Cross Sectional Area of Particle

ρ_{fluid}=Fluid Density

Vrel=Particle velocity relative to surrounding fluid

The viscous drag force equation may be selected for the given circumstance and may not be limited by those just described.

Taken together, the viscous drag force and the buoyancy force may act to accelerate each particle in a vibrating fluid, however, if the particles do not track the vibration amplitude and phase of the surrounding fluid, the vibrating element may not accurately sense the mass properties of the particles, thereby resulting in an apparent density or mass flow rate which is in error from the true density or mass flow rate.

In an example, a correction algorithm may be determined and applied, thereby reducing or altogether eliminating measurement error. This correction algorithm may utilize knowledge of the apparent density and/or mass flow rate as just described, the viscosity of the surrounding fluid, and the density, size, and shape of the included particles.

In an example, the techniques described herein may be implemented to accurately determine the density or mass flow rate of a slurry mixture of solid particles within a base fluid by the use of a vibrating element type sensor measuring viscosity and apparent density, and apparent mass flow rate, and by the use of particle property information including particle size, density, and shape. These data may be incorporated into an algorithm that corrects apparent density and/or mass flow rate into a true density or mass flow rate measurement.

In addition, once the density and mass flow rate and viscosity are known, other fluid parameters can be calculated including, but not limited to, the volume fraction or the mass fraction of the particles in the slurry mixture. Also, if the particles in the fluid are voids, a void fraction can be calculated.

Before continuing, it is noted that as used herein, the terms “includes” and “including” mean, but is not limited to, “includes” or “including” and “includes at least” or “including at least” The term “based on” means “based on” and “based at least in part on.”

It should be noted that the examples described above are provided for purposes of illustration, and are not intended to be limiting. Other devices and/or device configurations may be utilized to carry out the operations described herein.

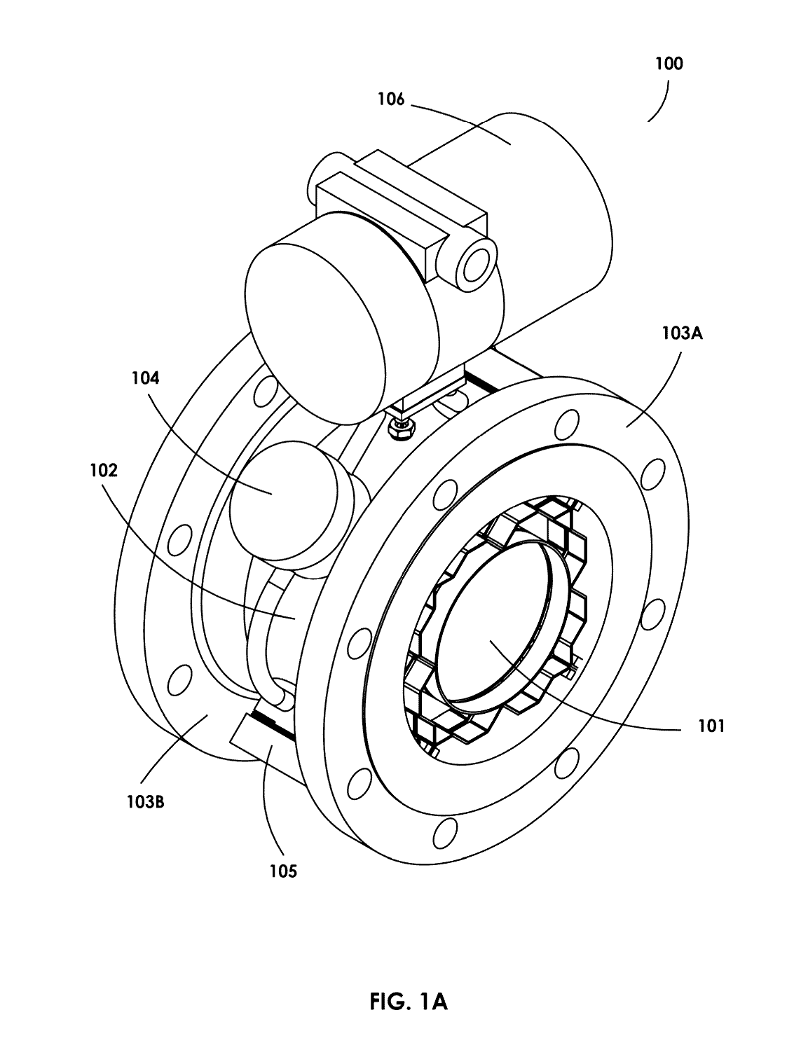

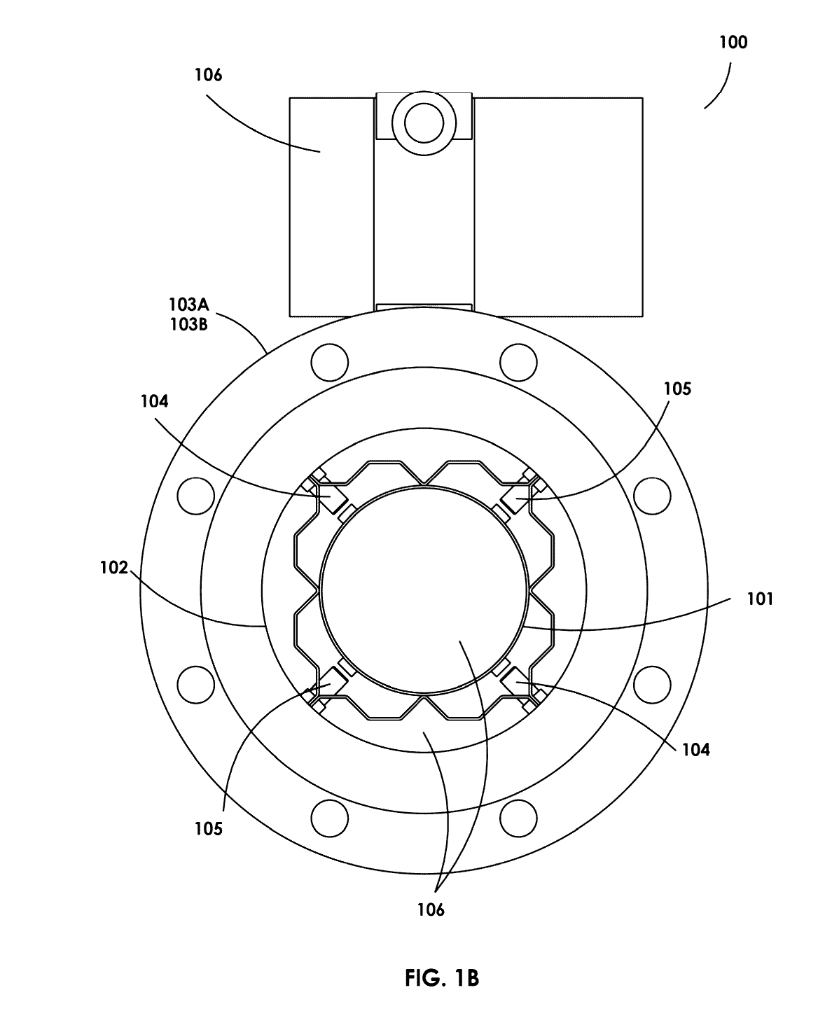

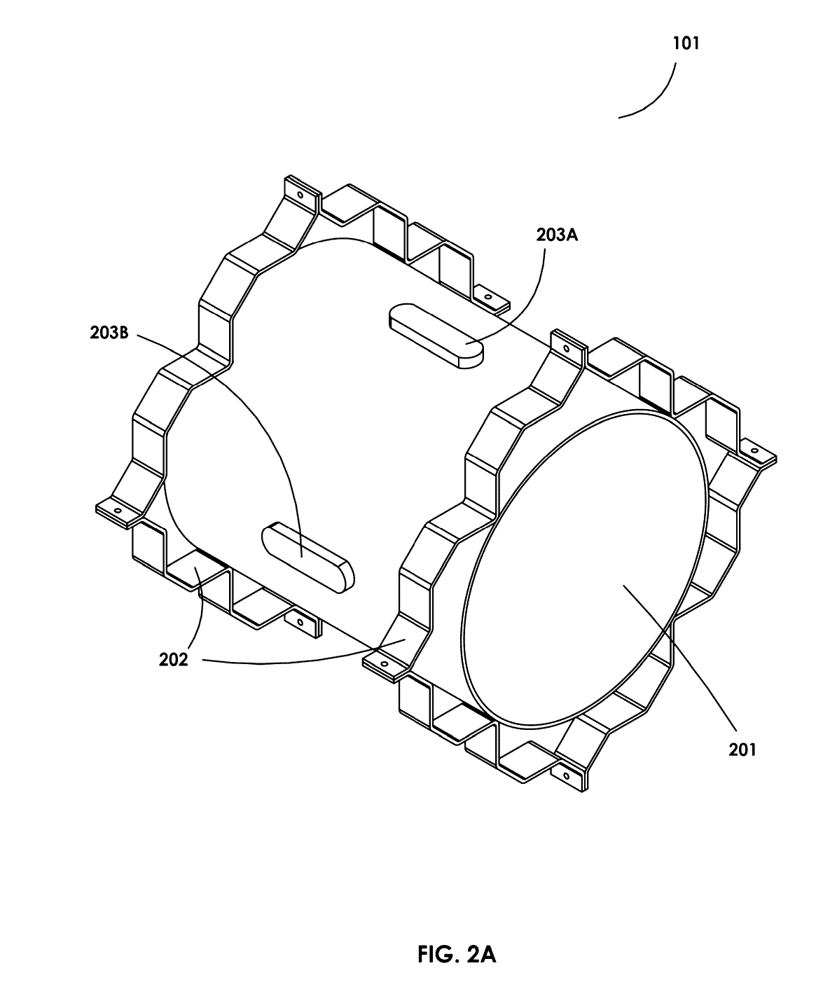

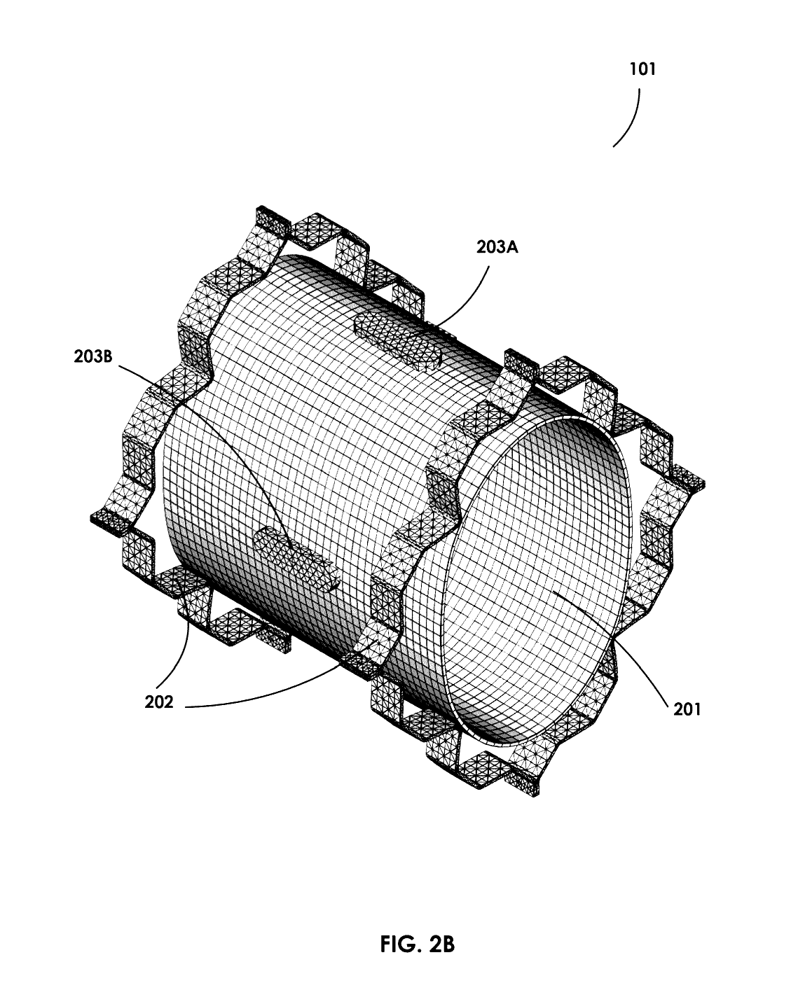

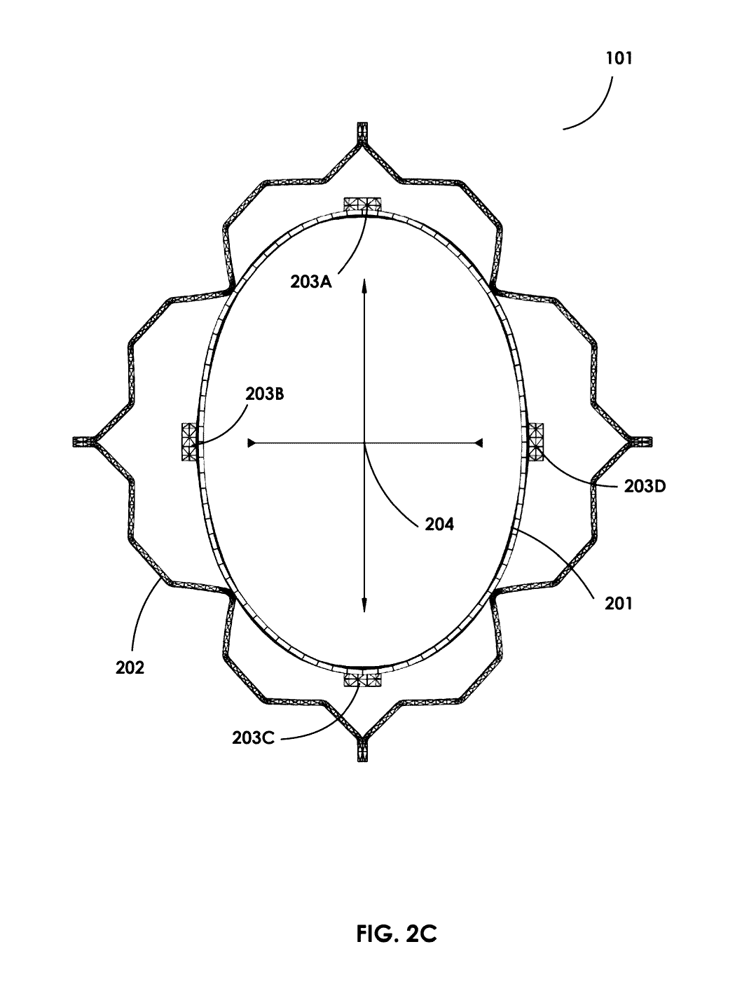

FIG. 1A shows an example process meter 100. In an example, process meter 100 is a vibrating element type process meter having a vibrating element assembly 101, as shown in more detail in FIG. 2A. In an example, vibrating element assembly 101 is arranged within a pipe assembly 102 with inlet and outlet pipe connections 103A and 1038. Pipe connections 103A and 1038 are shown as standard bolting type pipe flange connections such as those described by ANSI 816.5 standards, however they could also be any other type of connection such as, but not limited to, welded pipe, Victaulic type, Hammer Union type, compression type, and O-ring type.

In an example, electronics 106 are arranged in conjunction with pipe assembly 102, and control operation of vibrating assembly 101, as described in more detail below. Electronics 106 may be in communication with vibration sensors 104 and vibration drivers 105, which sense and drive respectively the requisite vibration of vibrating element assembly 101. Vibration sensors 104 and vibration drivers 105 are shown as electromagnetic type transducers which are generally known in the art, however they could be any other type of sensors and/or drivers.

FIG. 1B is a view down the axis of the process meter 100 showing the interior volume 106 of pipe assembly 102 wherein a fluid to be measured may be located and possibly flowing there through.

FIGS. 2A, 28, and 2C show detailed views of example vibrating element assembly 101 having vibrating element 201 which is shown as a tubular structure that may be made of any elastic durable material such as, but not limited to, metal, ceramic, and plastic. Examples of suitable materials for vibrating element 201 include, but not limited to, austenitic, or martensitic, or ferritic, or precipitation hardenable, or duplex type steels, stainless steel, ceramic, plastic, and titanium. Vibrating element 201 may be held in place in pipe assembly 102 by flexible brackets 202 which may be made of any durable elastic material as was just described for the vibrating element 201. In an example, flexible brackets 202 hold vibrating element 201 in its proper location within pipe assembly 102, while allowing vibrating element 201 to vibrate freely and to vibrationally interact with fluid contained within volume 106 of tube assembly 102.

In an example, magnetic armatures 203A, 2036, 203C, and 203D are fixedly attached to vibrating element 201, and are in magnetic communication with electromagnetic sensors 104 and electromagnetic drivers 105, such as to sense and to drive respectively the requisite vibration.

In an example, electromagnetic sensors 104 in conjunction with magnetic armatures 203A and 203C, sense vibration occurring on vibrating element 201. This sensed vibration is converted to electrical signals which may be conveyed to electronics 106 where they may be amplified, phase shifted to the correct phase, and conveyed to electromagnetic drivers 105. Electromagnetic drivers 105 receiving the amplified vibration signals from electronics 106, and acting in conjunction with magnetic armatures 203B and 203D, cause oscillatory forces on vibrating element 201 which cause and maintain the requisite vibration amplitude and frequency for operation.

If there is a pure fluid inside the volume 106 of pipe assembly 102, this pure fluid is influenced by the vibration of vibrating element 201 and vibrates proportionally related to the vibration of vibrating element 201. Equations 1, 2, and 3 above define the frequency of the combined vibrating element 201, including any vibrating fluid within volume 106.

FIGS. 2B and 2C are finite element analysis diagrams of example vibrating element assembly 101 showing the deflected shape of vibrating element 201 and the direction 204 of the vibration of element 201 to achieve this defected shape.

Process meter 100 may normally be calibrated before use as a density sensor, such as by first filling volume 106 with a common fluid with a known density such as air, and such as by recording the resulting vibration frequency. Next, volume 106 may be filled with a second fluid of a different known density such as water, and the resulting vibration frequency may be recorded. Knowing these two frequencies and, their associated fluid densities, a calibration algorithm may, be formulated which may predict the density of any fluid within volume 106 according to the resulting operating frequency. In an example, the algorithm follows a relationship between fluid density and the vibration frequency, as shown for example in Equations 2 and 3 above.

Similarly, process meter 100 may be calibrated before use as mass flow rate sensor. For example, calibration may be by first filling volume 106 with a common fluid such as water having a zero mass flow rate, and taking a first measurement of a vibration characteristic such as a vibration amplitude or vibration phase relating to a zero flow rate. Next, the fluid in volume 106 is caused to flow at a known flow rate, and a second measurement of a vibration characteristic such as vibration amplitude or vibration phase relating to a non-zero known flow rate is determined. Knowing these two vibration characteristics and their associated fluid flow rates, a calibration algorithm can be formulated to predict the mass flow rate of the fluid within volume 106 according to the resulting operating vibration characteristic change.

The techniques described herein may be applied to non-pure fluids, for example slurries and mixtures of pure fluids with particulate matter or bubbles or voids included. Since the effects of particulate matter are similar to the effects of bubbles or voids, the terms of particles or particulate matter hereinafter include, for example, bubbles or voids.

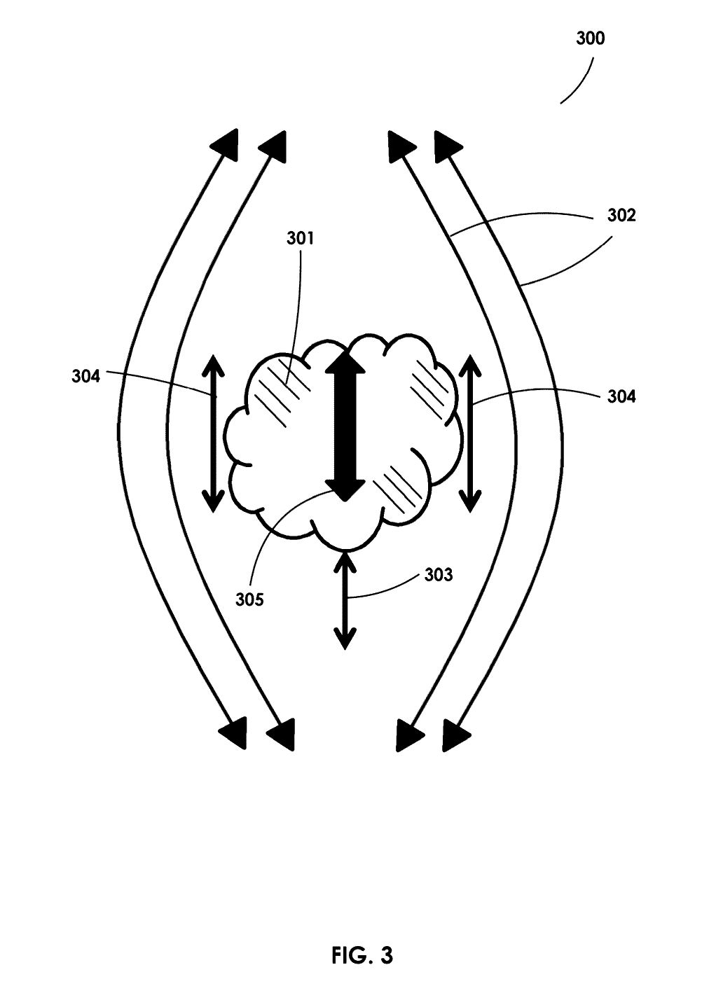

FIG. 3 shows an example fluid particle system 300 comprising a solid particle 301 immersed in a vibrating fluid 302. In an example, particle 301 enters into process meter 100 and is subjected to vibrating fluid 302. Since for this example, the density of the surrounding base fluid 302 is the same as the density of particle 301, a buoyancy force 303 may apply to particle 301, such as according to Equation 4 above, which acts to accelerate particle 301 the same as the surrounding fluid. Therefore the vibration motion 305 of particle 301 is substantially the same as the vibrating fluid 302, and there are no substantially no viscous drag forces 304. The density or mass flow rate calculated by process meter 100 is therefore accurate with no error due to particle slippage.

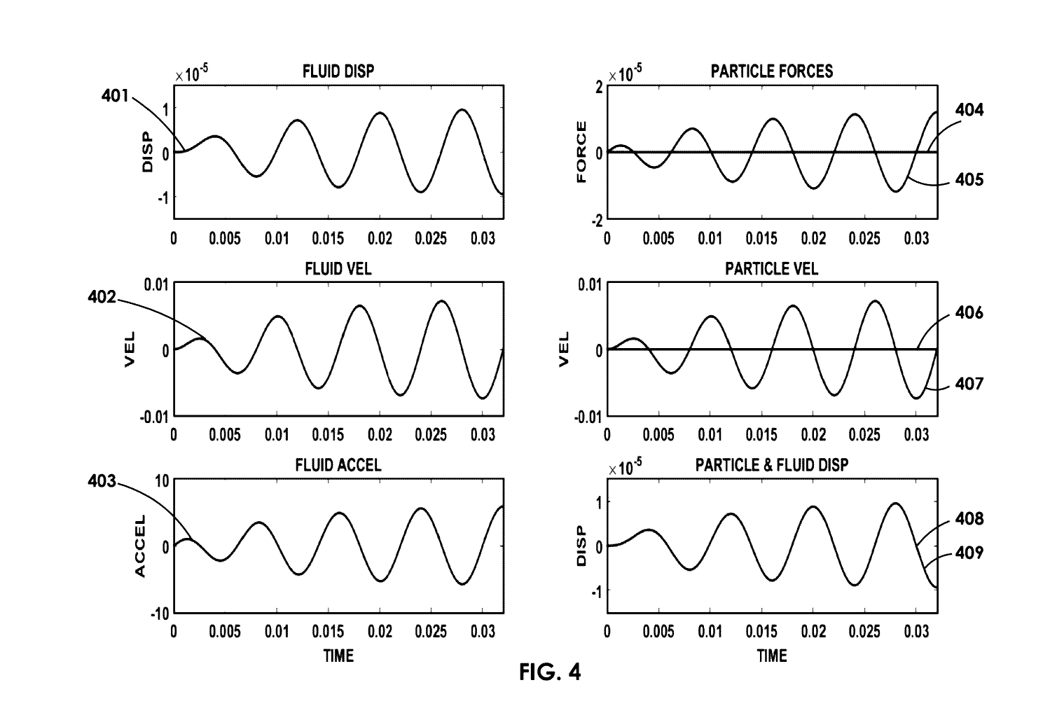

FIG. 4 shows several graphs of example fluid and particle vibration relationships vs. time in the circumstance where the fluid density is the same as the particle density, as described next. In graphical form, FIG. 4 shows example fluid displacement 401, fluid velocity 402, and fluid acceleration 403, versus time as the fluid 302 moves into the vibration influence of vibrating element 201 FIG. 4 also shows example drag and buoyancy forces 404 and 405 on the particle, the relative and absolute velocity 406 and 407 of the particle, and the displacement 408 and 409 of the fluid and the particle respectively. Since there is substantially no relative velocity 406 between the particle 301 and the vibrating fluid 302, there is also substantially no drag force 404 and 304, and the buoyancy force 405 is the only force acting on particle 301. As a result, the displacement 408 of particle 301 is substantially the same as the displacement 409 of the vibrating fluid 302, and therefore the mass of particle 301 can be properly sensed by process meter 100.

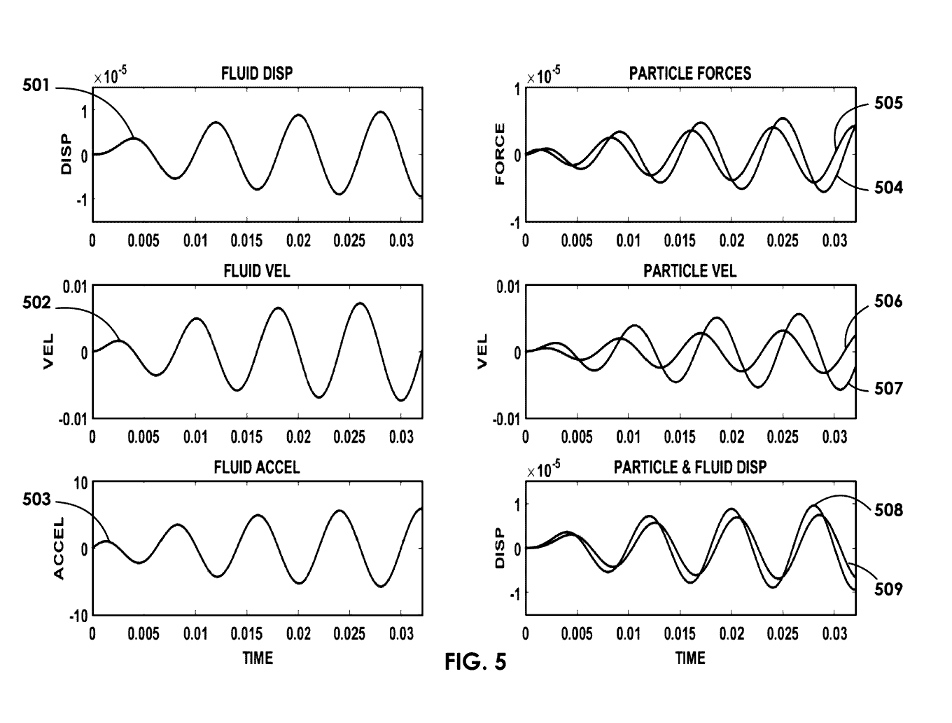

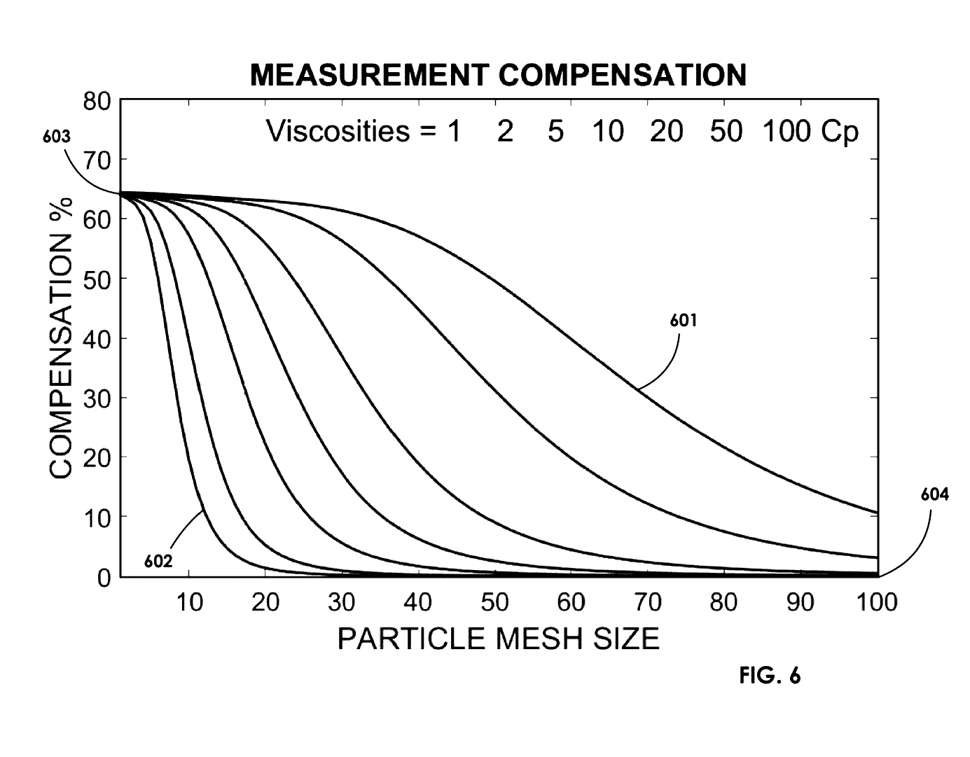

The circumstance where particle 301 has a heavier density than the surrounding base fluid density is now described with reference to FIGS. 3 and 5 FIG. 6 shows example fluid displacement 501, fluid velocity 502, and fluid acceleration 503, versus time due to the vibration of vibrating element 201. FIG. 5 also shows example drag and buoyancy forces 504 and 505 on the particle, the relative and absolute velocity 506 and 507 of the particle, and the displacement 508 and 509 of the fluid and the particle. Since the density of particle 301 is for this example heavier than that of the vibrating base fluid 302, the buoyancy force 505 and 303 may not be adequate to accelerate particle 301 to the same velocity 507 as the fluid velocity 502, the difference being the relative velocity 506. The relative velocity 506 then may cause drag forces 504 and 304 on particle 301 which in combination with buoyancy force 505, cause its displacement 509 to be slightly less than the displacement 508 of the surrounding fluid In this example, the full mass of particle 301 therefore may not be entirely sensed by process meter 100 and the indicated apparent density or apparent mass flow rate may be in error. A correction algorithm for this error may now be described.

Using the buoyancy Equation 4 above in combination with a viscous drag force equation such as Equations 5, or 6, or 7 as herein described or some other alternate viscous drag force equation, also using particle density, size and shape information, an algorithm, such as but not limited to a computer program, may calculate and integrate the buoyancy forces 505 and 303 and the drag forces 504 and 304 on particle 301 over incremental time during the vibration of the vibrating fluid 302.

FIGS. 4, 5, and 6 show the, result of such calculations, where the density compensation percent on FIG. 6 is on the vertical axis, and particle size (mesh size) is on the horizontal axis. Seven different viscosities are analyzed and plotted with line 601 representing a viscosity of one centipoise such as water, and line 602 being 100 centipoise.

The data presented in FIGS. 4, 5, and 6 was calculated by a computer program using a base fluid density of 998 kilograms per cubic meter (similar to water), a particle density of 3200 kilograms per cubic meter (similar to ceramic propant), and a particle sphericity of 0.5 (a typical value for some propants). The computer program calculates the forces, accelerations, velocities and displacements on a representative particle as it is subjected to the motion of the base fluid in which it is submerged. The combination of buoyancy forces, and viscous drag forces are applied to the particle by the program in a step-by-step process using small time increments to simulate the physics of the situation and thereby converge to accurate predictive results. The resulting predicted particle motion is then compared to the base fluid motion and a compensation value can then be determined proportionally related to the ratio of those two motions. For example if the particle predicted motion is 75% of the base fluid motion, then a 25% compensation value may compensate for the missing 25% mass effect.

Alternately, the behavior of the particles can be determined by actual testing of various particle sizes, densities, shapes, in varying fluid viscosities, and the results accumulated in a data base. The resulting database can then be used to determine compensation values which can then be applied as shown in Equations 8A through 8B below. The results of such empirical data can also be plotted in a form similar to FIG. 6, and used in a similar way as the calculated results just described.

FIG. 6 is a graph comparing Density Compensation percent value for different example particle mesh sizes and fluid viscosities. Visual examination of FIG. 6 indicates that at any viscosity, and at very large particle size indicated by small mesh size, all curves converge to a single error 603 or compensation value of about 63%. In this area of the chart 603, viscous drag forces are minimal, and buoyancy forces dominate, and the 63% predicted compensation value is primarily driven by the difference in density between the base fluid and the particle.

Area 604 on FIG. 6 represents the opposite extreme where the lines are converging toward zero error. This area 604 may be where particle sizes are small—indicated by large mesh size and the higher viscosity fluids may have far lower compensation values than the lower viscosity fluids. This area 604 is dominated by viscous drag forces and buoyancy forces are minimal.

Families of curves for different viscosities and mesh sizes can be calculated or determined either theoretically or empirically as shown in FIG. 6, and the results stored as compensation values, such as in a lookup table or plot, and applied to the apparent density or the apparent mass flow rate indicated by process meter 100.

Examples of compensation algorithms for density and mass flow rate are shown below in Equations 8A through 8B. These example algorithms are illustrative and are not exhaustive. Other compensation algorithms can be formulated and implemented.

ρₜᵣᵤₑ=ρ_{base}+(ρ_{ind}−ρ_{base})*(1+ρ_{comp%}) EQ 8A

Where:

ρₜᵣᵤₑ=True Density of Si Shiny Mixture

ρ_{base}=Density of Base Fluid
ρ_{ind}=Indicated Density of Slurry Mixture

ρ_{comp%}=Compensation % from Table (FIG. 6)

For example, if the density of the base fluid ρ_{base} is 1000, and the indicated density of the slurry mixture ρ_{ind} is 1100, and the predicted compensation value from calculations (FIG. 6) is 50%, then the true density of the slurry mixture ρₜᵣᵤₑ can be calculated as follows:

ρₜᵣᵤₑ=1000+(100−1000)*(1+0.5)=1150

In the case of a vibrating element type Coriolis mass flow rate meter, the Coriolis forces that are developed due to the interaction of mass flow rate and element vibration may be in error due to the same phenomenon just described which causes a density error. Therefore, a nearly identical algorithm can be used to compensate indicated mass flow rate either using the base fluid density parameters, or the base fluid flow rate parameters as shown below in Equation 8B:

Mdotₜᵣᵤₑ=Mdot_{base}+(Mdot_{ind}−Mdot_{base})*(1+ρ_{comp%}) EQ 8B

Where:

Mdotₜᵣᵤₑ=True Mass Flow Rate of Slurry Mixture

Mdot_{base}=Mass Flow Rate of Base Fluid

Mdot_{ind}=Indicated Mass Flow Rate of Slurry Mixture

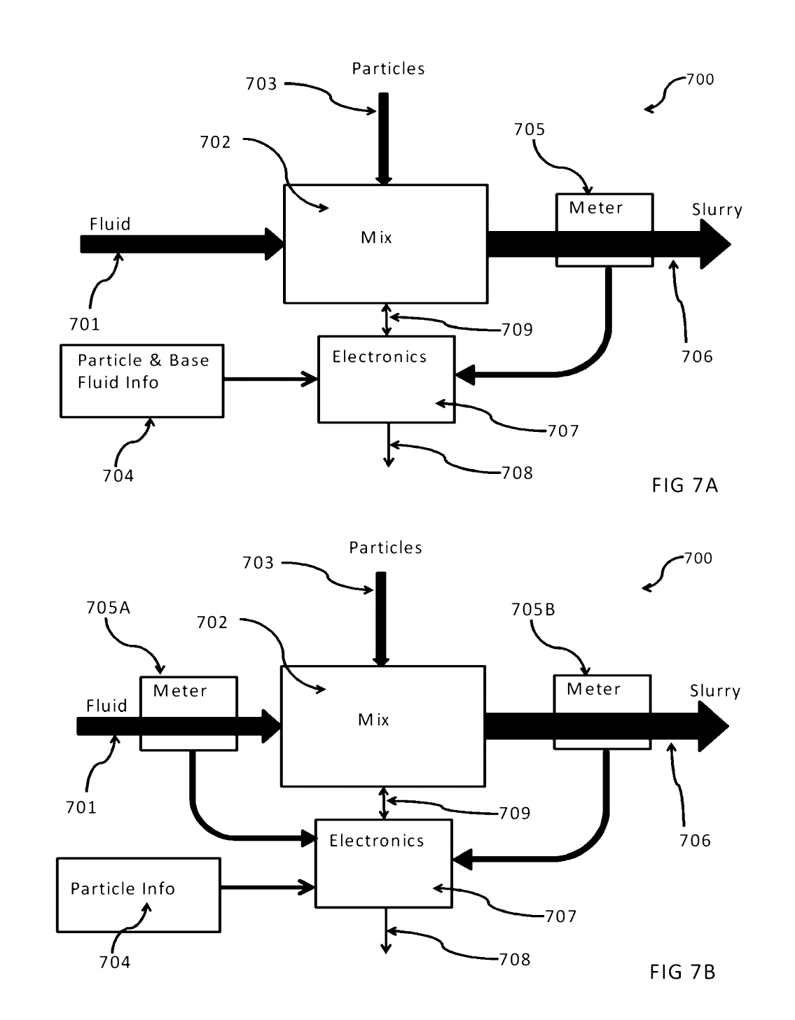

FIG. 7A is, a block diagram of the example process method 700, where fluid 701 is blended in a mixer 702 with particles 703. The resulting slurry 706 may be measured by process meter 705 and the measured apparent density and mass flow rate and viscosity calculated, such as by electronics 707. By the addition of base fluid and particle information of density, size and shape 704, electronics 707 thereby corrects the apparent density and mass flow rate as measured by process meter 705 such as by calculating and applying the correction factor such as was just described which may take the particle information 704 and measured viscosity into account for the correction. The corrected output 708 can be used and recorded by the user. Also the mixing process can be controlled by an output 709 interacting with the mixer such as to control a true density and/or a true mass flow rate in a closed loop method.

FIG. 7B is a block diagram of the example process method 700, where fluid 701 is first measured by process meter 705A, then blended in a mixer 702 with particles 703. In an example, the resulting slurry 706 is measured by a second process meter 705B and the measured apparent mass flow rate, density and viscosity calculated, such as by electronics 707. By the addition of base fluid mass flow rate and density information from a process meter 705A, and particle information of density, size and shape 704, electronics 707 thereby corrects the apparent mass flow rate and density as measured by process meter 705B such as by calculating and applying the correction factor such as was just described which may take the particle information 704 and measured viscosity into account for the correction. The corrected output 708 can be used and recorded by the user. Also the mixing process can be, controlled by an output 709 interacting with the mixer such as to control a true mass flow rate and/or a true density in a dosed loop method.

Viscosity Measurement. Process meter 100 can also be implemented directly to determine fluid viscosity. For density compensation as described above, the determination of viscosity may also be from a separate viscosity sensor, such as with an input to electronics 707 (not shown).

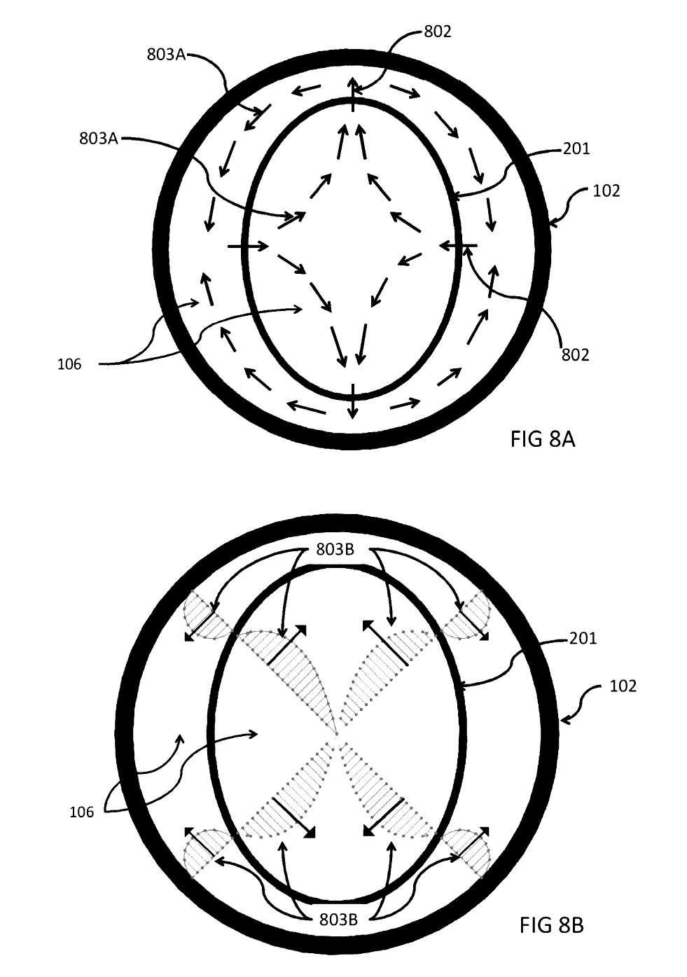

The operation of process meter 100 as a slurry viscosity sensor is now described with reference to FIGS. 8A and 8B. FIG. 8A shows an example cross section view through pipe 102 and vibrating element 201, showing the motion 802 of vibrating element 201 and the resulting fluid motions 803A in volume 106 FIG. 8B shows example velocity profiles 8036 resulting from fluid motion 803A.

The dynamic viscosity of a fluid can be described as the shear stress associated with a certain rate of change in the fluid velocity or velocity profile as a function of distance from the wall, as in Equation 9 below.

μ=τ/(dV/dY) Eq 9

Where:

μ=Fluid Dynamic Viscosity

τ=Shear Stress

dV/dY=Velocity Profile

To determine viscosity from process meter 100, the shear stress in Equation 9 above may be determined by the amount of force required to vibrate vibrating element 201 to a prescribed amplitude. Since electromagnetic sensors 104 and drivers 105 may sense and cause the requisite element 201 vibration as earlier described, electronics 707 determines a viscosity metric proportionally related to fluid viscosity, for example as follows. The magnitude of driving force on vibrating element 201 is proportional to the current supplied to vibration drivers 105, and this may be proportional to the shear stress term in Equation 8 above.

The magnitude of the resulting vibrating element motion 802 may be directly sensed by motion sensor 104, for example as earlier described, and is proportional to the velocity profile term in Equation 9 above. Electronics 707 then determines a viscosity metric by dividing the magnitude of the supplied current by the magnitude of the resulting velocity of vibrating element 201, for example as in Equation 10 below:

μ=Force(supplied current)/Velocity Eq 10

Where:

μ=Fluid Dynamic Viscosity metric

Force (supplied current)=Amperes supplied to driving coils

Velocity=Velocity Profile

FIGS. 8A and 8B indicate vibrating element motion 802, and fluid motion 803A and 8036 as earlier described. Also as earlier described, a particle such as particle 301 may not vibrate with the same amplitude and phase as the fluid 302 in which it is submerged. Therefore in the case of measuring a viscosity metric, the velocity term of Equation 10 above does not fully take into account the velocity of the particles 301 if they are moving relative to the vibrating fluid 302, thereby causing an error in the viscosity metric.

Therefore, a compensation algorithm can be determined similar to those earlier described in Equations 8A and 8B to correct the indicated viscosity metric by a compensation value based on the base fluid viscosity metric, the measured indicated viscosity metric, and particle physical parameters, just as before. An example compensation algorithm for viscosity metric may have the form as expressed by Equations 8A and 8B, such as in Equation 11 as follows:

μₜᵣᵤₑ=μ_{base}+(μ_{ind}−μ_{base})*(1+ρ_{comp%}) EQ 11

Where:

μₜᵣᵤₑ=True Viscosity of Slurry Mixture

μ_{base}=Viscosity of Base Fluid
μ_{ind}=Indicated Viscosity of Slurry Mixture

ρ_{comp%}=Compensation % from FIG. 6

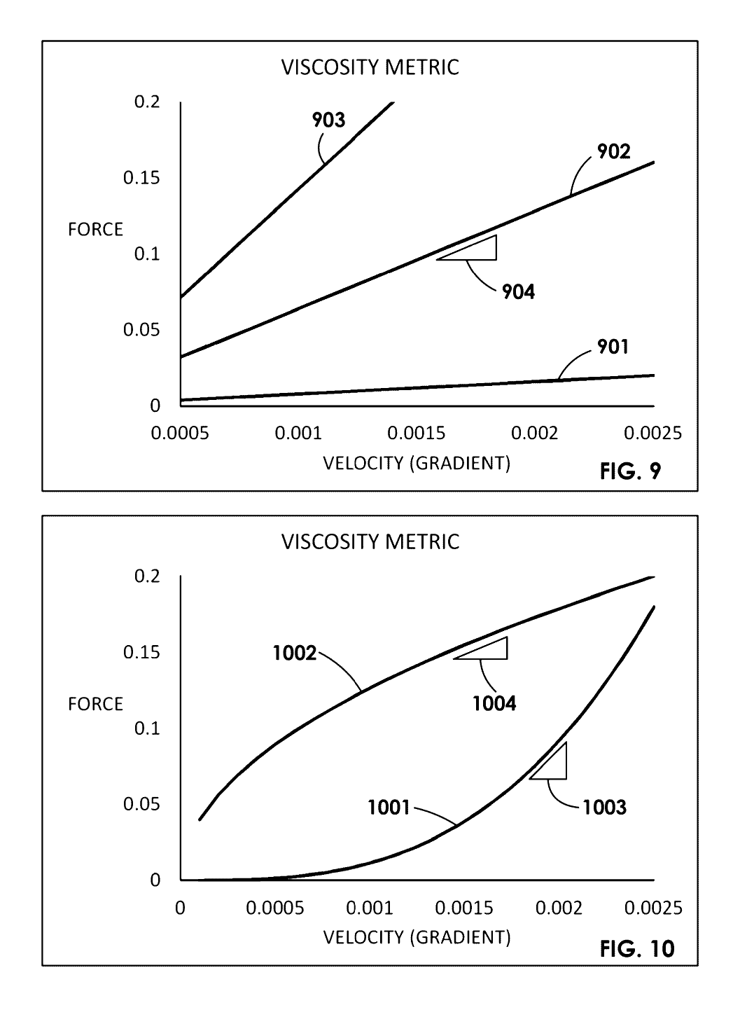

FIG. 9 is a graph of Force vs. Velocity curves for three different fluids with different viscosities. Curve 901 includes data from water having a viscosity of approximately 1 centipoise. Curve 902 includes data from a mixture of 90% glycerine and 10% water having a viscosity of approximately 220 centipoise. Curve 903 include data from pure glycerine having a viscosity of approximately 1410 centipoise. Since glycerine and water and mixtures of the two are generally Newtonian in nature, the slope of each curve 901, 902, and 903 is an approximate straight line with a zero intersection point (not shown). The slope 904 of curve 902 is proportionally related to the viscosity of that fluid.

In the case of Newtonian fluids a single data point on the curve may be sufficient to determine viscosity since the slope may be determined therefrom. However, many industrial fluids, for example fracking fluids, are non-Newtonian and their viscosity changes as a function of, for example, shear rate or velocity gradient.

FIG. 10 is a graph showing non-Newtonian fluid characteristics. Curve 1001 shows an increasing slope 1003 with increasing velocity and the slope 1003 changes along the length of curve 1001. This behavior is referred to as “shear-thickening,” since the viscosity increases (e.g. becomes thicker) with increasing velocity gradient.

Similarly, curve 1002 shows a decreasing slope 1004 with increasing velocity, and this behavior may be called shear-thinning. For non-Newtonian fluids having non-linear curves such as curves 1001 and 1002, viscosity may not be a constant value, and therefore often is specified at a given shear rate.

The viscosity metric just described can be calibrated in customary units such as centipoise, for example by determining the viscosity metric on two or more fluids of known viscosity. Then an algorithm converts the viscosity metric into centipoise or some other viscosity unit. For example, referring to FIG. 9, a first fluid such as water may be measured, resulting in curve 901 as previously mentioned. The slope of this curve 901 corresponds to a viscosity of 1 centipoise. A second fluid such as glycerine may be measured resulting in curve 903 as previously mentioned. The slope of this curve is a constant value which corresponds to a viscosity of 1410 centipoise. Therefore, the algorithm to convert viscosity metric units to centipoise may be a look-up table or plot, or a mathematical function relating viscosity metric to centipoise. In addition to centipoise, other viscosity units may be used such as stokes or others.

Similar to the density and mass flow rate measurements described above, and, their compensation algorithms due to particle motion as shown in Equations 8A and 8B, the indicated viscosity measurement as just described may also be in error due to particle motion, and may therefore implement a similar compensation algorithm as described above for FIGS. 8A and 8B.

Compensation of Non Linear Effects. In addition to a linear type algorithm for determining density and/or mass flow rate as described above, certain types of vibrating elements are subject to nonlinear effects while measuring fluid density and/or mass flow rate due to viscosity effects. This may happen, for example, when changes in fluid viscosity cause the modal mass of the vibrating fluid within a vibrating element type sensor to change thereby causing an error in the density and/or mass flow rate measurement.

Therefore, a viscosity metric related compensation can be applied to either the density or the mass flow rate measurements as described above proportionally related to the viscosity metric as measured by process meter 100.

Calculation of additional fluid parameters. Once the slurry density is determined, such as was described above, other fluid parameters such as volume fraction and mass fraction may be calculated. For example, a formula for calculating volume fraction may be the following Equation 12:

CV=(ρₘ/ρ_{w}−1)/(ρₛ/ρ_{w}−1) Eq 12

Where:

CV=Volume Concentration of Solid Particles

ρₘ=Density of Slurry Mixture

ρₛ=Density of Solid Particles

ρ_{w}=Density Base Liquid

As described above, the density of the slurry mixture, the solid particles and the base liquid may be all known in advance or may be determined by the process meter, therefore the Volume concentration “CV” of the solid particles in the slurry mixture may be determined in the electronics such as by applying Equation 11 above.

Similarly, mass concentration may also be calculated, such as in Equation 13:

CM=CV*ρₛ/ρₘ Eq 13

Where:

CM=Mass Concentration of Solid Particles

CV=Volume Concentration of Solid Particles (from Eq 12)

ρₛ=Density of Solid Particles

ρₘ=Density of Slurry Mixture

It is noted that the examples shown and described are provided for purposes of illustration and are not intended to be limiting. Still other examples are also contemplated.

1. A process meter for measuring the density of a slurry mixture of base fluid and particles, comprising:
a vibrating element to vibrate the slurry mixture, and having a vibration frequency proportionally related to density of the slurry mixture;
control electronics configured to operate the vibrating element to vibrate the slurry mixture, the control electronics further configured to determine an uncompensated density measurement related to the vibration frequency;
physical parameter data of the base liquid and particles comprising he density of the base liquid, the size, shape, and density of the particles;
a viscosity metric proportionally related to the viscosity of the slurry mixture;
an algorithm for compensating an uncompensated density measurement for error due to particle slippage comprising the uncompensated density measurement, and the physical parameter data of the base liquid and particles, and the viscosity metric; and
wherein the control electronics is further configured to apply the algorithm to the uncompensated density measurement thereby causing the measuring the density of a slurry mixture.

2. The process meter of claim 1, wherein the viscosity metric is determined by the control electronics.

3. The process meter of claim 1, wherein the viscosity metric is a function of the force applied to the vibrating element

4. The process meter of claim 1, wherein the viscosity metric is a function of the velocity of the vibrate the slurry mixture.

5. The process meter of claim 1, further comprising a separate viscosity sensor with an input to the control electronics, the separate viscosity sensor to determine the viscosity metric.

6. The process meter of claim 1, wherein the algorithm comprises a lookup table of values relating a density compensation value to the physical parameter data of the particles, and the viscosity metric.

7. The process meter of claim 1, wherein the algorithm determines volume fraction of solid particles.

6. The process meter of claim 1, wherein the algorithm determines mass fraction of solid particles.

9. The process meter of claim 1, wherein the algorithm determines a compensation proportionally related to the viscosity metric.

10. A process meter for measuring the mass flow rate of a slurry mixture of base liquid and particles, comprising:
a vibrating element configured to vibrate the slurry mixture, and having a vibration characteristic proportionally related to the mass flow rate of the slurry mixture;
control electronics configured to cause the vibrate the slurry mixture, the control electronics further configured to determine an uncompensated mass flow rate measurement related to the vibration characteristic;
physical parameter data of the base liquid and particles comprising the mass flow rate of the base liquid, the size, shape, and density of the particles;
a viscosity metric proportionally related to the viscosity of the slurry mixture;
an algorithm for compensating the uncompensated mass flow rate measurement for error due to particle slippage comprising the uncompensated mass flow rate measurement, and the physical parameter data of the base liquid and particles, and the viscosity metric; and
wherein the control electronics is further configured to apply the algorithm to the uncompensated mass flow rate measurement thereby causing the measuring the mass flow rate of a slurry mixture.

11. The process meter of claim 10, wherein the viscosity metric is determined by the control electronics.

12. The process meter of claim 10, wherein the viscosity metric is a function o the force applied to the vibrating element.

13. The process meter of claim 10, wherein the viscosity metric is a function of the velocity of the vibrate the slurry mixture.

14. The process meter of claim 10, wherein the viscosity metric is determined by a separate viscosity sensor with an input to the control electronics.

15. The process meter of claim 10, wherein the algorithm comprises a lookup table of values relating a density compensation value to the physical parameter data of the particles, and the viscosity metric.

16. A process meter for measuring a viscosity metric of a slurry mixture of base liquid and particles, comprising:
a vibrating element to vibrate the slurry mixture, and having a vibration characteristic proportionally related to the viscosity metric of the slurry mixture control electronics configured to cause the vibrate the slurry mixture, the control electronics further configured to determine an uncompensated viscosity metric related to the vibration characteristic.

17. The process meter of claim 16, further comprising physical parameter data of the base liquid and particles comprising the viscosity of the base liquid, the size, shape, and density of the particles.

18. The process meter of claim 17, further comprising an algorithm for compensating the uncompensated viscosity metric for error due to particle slippage comprising the uncompensated viscosity metric, and the physical parameter data of the base liquid and particles

19. The process meter of claim 18, wherein the control electronics further configured to apply the algorithm to the uncompensated viscosity metric thereby causing the measuring a viscosity metric of a slurry mixture.
